(19) United States
(12) Patent Application Publication
(10) Pub. No.: US 2026/0301471 A1
(43) Pub. Date: Oct. 1, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventors: Kazuya KAKIZAKI, Tokyo (JP); Takuma AMADA, Tokyo (JP); Masahiro BUSSAKI, Tokyo (JP); Toshinori ARAKI, Tokyo (JP)

(73) Assignee: NEC Corporation, Tokyo (JP)

(21) Appl. No.: 19/489,935

(22) PCT Filed: Jun. 20, 2023
(86) PCT No.: PCT/JP2023/022755

§ 371 Date: Dec. 4, 2025

(51) Int. Cl. G06V 40/40; G06T 11/00; G06V 10/44; G06V 10/74; G06V 40/16

(52) U.S. Cl. CPC G06V 40/40; G06T 11/00; G06V 10/44; G06V 10/761; G06V 40/171; G06V 40/172

(57) ABSTRACT

An information processing apparatus including: a receiving means for receiving input of a first image and a second image; a synthesis means for generating a third image based on the first image and the second image; a difference emphasis means for emphasizing a difference between the second image and the third image; a calculation means for calculating an index representing a likelihood that the second image is a synthetic image based on the difference emphasized; and a determination means for determining whether the second image is a synthetic image based on the index.

### TECHNICAL FIELD

This disclosure relates to the technical field of information processing apparatus, information processing methods, and recording media.

### BACKGROUND ART

Patent Literature 1 discloses a technology for detecting whether a video is a fake video (e.g., a false video generated by synthetic processing, etc.). This technology uses a class indicating whether a person's face (object) is real (true) or fake (false), and detects elements of the target detection class, specifically synthesized regions (i.e., regions added to the original video).

### CITATION LIST

### Patent Literature

Patent Literature 1: WO2022/054246A

### SUMMARY

The present disclosure aims to provide an information processing apparatus, an information processing method, and a recording medium that accurately detect whether an input image is a synthetic image.

### Solution to Problem

An information processing apparatus according to an example aspect includes: a receiving means for receiving input of a first image and a second image; a synthesis means for generating a third image based on the first image and the second image; a difference emphasis means for emphasizing a difference between the second image and the third image; a calculation means for calculating an index representing a likelihood that the second image is a synthetic image based on the difference emphasized; and a determination means for determining whether the second image is a synthetic image based on the index.

An information processing method according to an example aspect includes receiving input of a first image and a second image; generating a third image based on the first image and the second image; emphasizing a difference between the second image and the third image; calculating an index representing a likelihood that the second image is a synthetic image based on the difference emphasized; and determining whether the second image is a synthetic image based on the index.

A recording medium according to an example aspect is a recording medium on which a computer program that allows a computer to execute an information processing method is recorded, the information processing method including receiving input of a first image and a second image; generating a third image based on the first image and the second image; emphasizing a difference between the second image and the third image; calculating an index representing a likelihood that the second image is a synthetic image based on the difference emphasized; and determining whether the second image is a synthetic image based on the index.

The information processing apparatus, information processing method, and recording medium according to the present disclosure can accurately detect whether an input image is a synthetic image.

### BRIEF DESCRIPTION OF DRAWINGS

FIG. 1 is a block diagram illustrating a configuration of an information processing apparatus according to this disclosure.

FIG. 2 is a block diagram illustrating a configuration of an information processing apparatus according to this disclosure.

FIG. 3 is a flowchart illustrating a flow of an information processing operation of an information processing apparatus according to this disclosure.

FIG. 4 is a block diagram illustrating a configuration of an information processing apparatus according to this disclosure.

FIG. 5 is a flowchart illustrating a flow of an information processing operation of an information processing apparatus according to this disclosure.

FIG. 6 is a block diagram illustrating a configuration of an information processing apparatus according to this disclosure.

FIG. 7 is a flowchart illustrating a flow of an information processing operation of an information processing apparatus according to this disclosure.

### DESCRIPTION OF EXAMPLE EMBODIMENTS

The following describes example embodiments of the information processing apparatus, information processing method, and recording medium with reference to the drawings.

### 1: First Example Embodiment

The first example embodiment of the information processing apparatus, information processing method, and recording medium is described. The following describes the first example embodiment of the information processing apparatus, information processing method, and recording medium using a first information processing apparatus 1 of the present disclosure.

### 1-1: Configuration of the Information Processing Apparatus 1

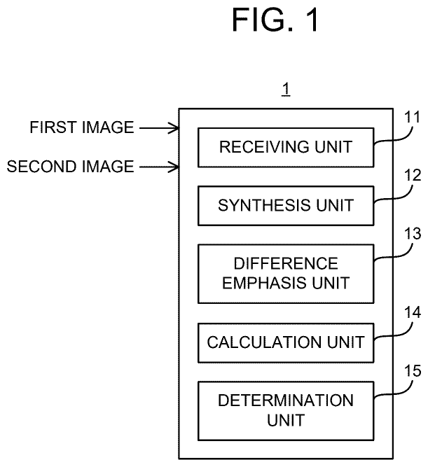

FIG. 1 is a block diagram showing the configuration of the first information processing apparatus 1 according to the present disclosure. As shown in FIG. 1, the information processing apparatus 1 includes a receiving unit 11, a synthesis unit 12, a difference emphasis unit 13, a calculation unit 14, and a determination unit 15. The receiving unit 11 receives input of a first image and a second image. The synthesis unit 12 generates a third image based on the first image and the second image. The difference emphasis unit 13 emphasizes the difference between the second image and the third image. The calculation unit 14 calculates an index representing a likelihood that the second image is a synthetic image based on the difference emphasized. The determination unit 15 determines whether the second image is a synthetic image based on the index.

### 1-2: Technical Effects of the Information Processing Apparatus 1

The first information processing apparatus 1 according to the present disclosure performs determination based on the difference between the input image and the synthetic image, enabling accurate detection of whether the input image is the synthetic image.

### 2: Second Example Embodiment

The second example embodiment of the information processing apparatus, information processing method, and recording medium is described. The following describes the second example embodiment of the information processing apparatus, information processing method, and recording medium using the second information processing apparatus 2 of the present disclosure.

### 2-1: Fake Image

There exists technology for synthesizing an image of a person based on information from a single photograph of that person's face. As an example of image synthesis technology for people, deepfake is known. Deepfake is known as a technology for synthesizing fake images depicting events that did not actually occur. Hereinafter, an image depicting an event that did not actually occur may be referred to as the fake image. A synthetic image may also be referred to as the fake image. An image depicting an event that actually occurred may be referred to as a real image.

### 2-2: Configuration of the Information Processing Apparatus 2

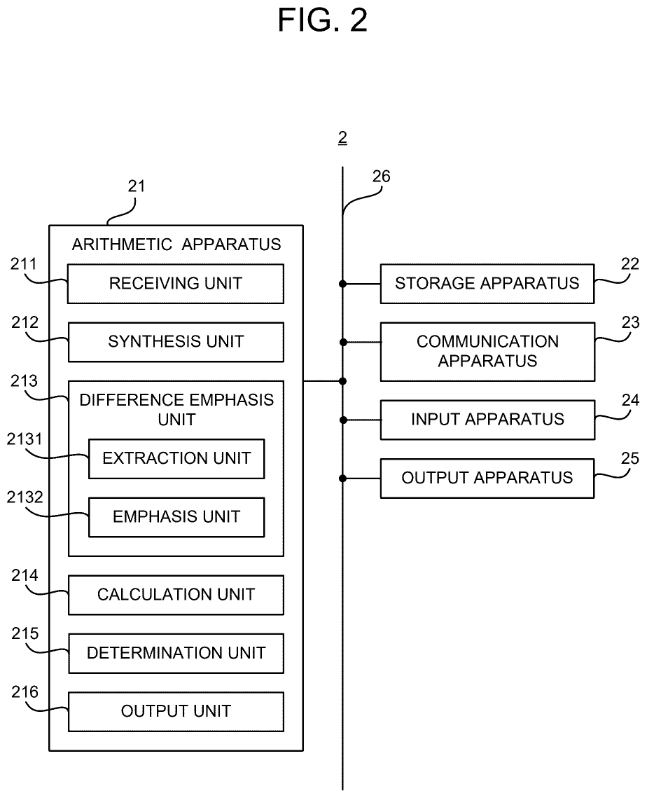

FIG. 2 is a block diagram showing the configuration of the second information processing apparatus 2. As shown in FIG. 2, the information processing apparatus 2 includes an arithmetic apparatus 21 and a storage apparatus 22. Furthermore, the information processing apparatus 2 may also include a communication apparatus 23, an input apparatus 24, and an output apparatus 25. However, the information processing apparatus 2 need not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 may be, for example, a CPU (Central Processing Unit), a GPU (Graphics Processing Unit), and an FPGA (Field Programmable Gate Array). The arithmetic apparatus 21 reads a computer program. For example, the arithmetic apparatus 21 may read a computer program stored in the storage apparatus 22. For example, the arithmetic apparatus 21 may read a computer program stored on a computer-readable, non-transitory storage medium using a storage medium reading apparatus (e.g., the later-described the input apparatus 24) provided in the information processing apparatus 2. The arithmetic apparatus 21 may obtain (i.e., download or read) a computer program from an unillustrated apparatus located outside the information processing apparatus 2 via the communication apparatus 23 (or other communication apparatus). The arithmetic apparatus 21 executes the read computer program. As a result, the arithmetic apparatus 21 implements logical functional blocks for executing operations that the information processing apparatus 2 should perform. That is, the arithmetic apparatus 21 can function as a controller to implement logical functional blocks for executing operations (in other words, processing) that the information processing apparatus 2 should perform.

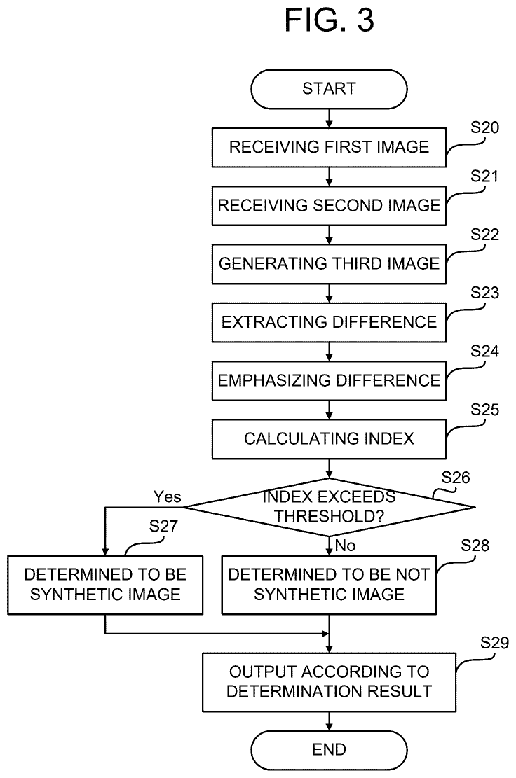

FIG. 2 shows an example of a logical functional block realized within the arithmetic apparatus 21 to execute information processing operations. As shown in FIG. 2, within the arithmetic apparatus 21 are: a receiving unit 211, which is one specific example of the “receiving means” described in the Supplemental Note to be described later; a synthesis unit 212, which is one specific example of the “synthesis means” described in the Supplemental Note to be described later; a difference emphasis unit 213, which is one specific example of the “difference emphasis means” described in the Supplemental Note to be described later; a calculation unit 214, which is one specific example of the “calculation means” described in the Supplemental Note to be described later; a determination unit 215, which is one specific example of the “determination means” described in the Supplemental Note to be described later; and an output unit 216 are implemented. However, the output unit 216 need not be implemented within the arithmetic apparatus 21. The difference emphasis unit 213 may include an extraction unit 2131 and an emphasizing unit 2132. The details of the operation of the receiving unit 211, the synthesis unit 212, the difference emphasis unit 213, the calculation unit 214, the determination unit 215, and the output unit 216 will be explained later with reference to FIG. 3.

The storage apparatus 22 is capable of storing desired data. For example, the storage apparatus 22 may temporarily store a computer program executed by the arithmetic apparatus 21. The storage apparatus 22 may temporarily store data temporarily used by the arithmetic apparatus 21 in case where the arithmetic apparatus 21 is executing the computer program. The storage apparatus 22 may store data that the information processing apparatus 2 stores long-term. Note that the storage apparatus 22 may include at least one of RAM (Random Access Memory), ROM (Read-Only Memory), a hard disk apparatus, an optical magnetic disk apparatus, an SSD (Solid State Drive), and a disk array apparatus. In other words, the storage apparatus 22 may include non-volatile recording media.

The communication apparatus 23 is capable of communicating with apparatuses external to the information processing apparatus 2 via an unillustrated communication network. The communication apparatus 23 may be a communication interface based on standards such as Ethernet (registered trademark), Wi-Fi (registered trademark), Bluetooth (registered trademark), or USB (Universal Serial Bus).

The input apparatus 24 is an apparatus that accepts input of information to the information processing apparatus 2 from outside the information processing apparatus 2. For example, the input apparatus 24 may include an operating apparatus operable by an operator of the information processing apparatus 2 (e.g., at least one of a keyboard, a mouse, and a touch panel). For example, the input apparatus 24 may include a reading apparatus capable of reading information recorded as data on a recordable medium that can be externally attached to the information processing apparatus 2.

The output apparatus 25 is an apparatus that outputs information to the external environment of the information processing apparatus 2. For example, the output apparatus 25 may output information as an image. That is, the output apparatus 25 may include a display apparatus (so-called display) capable of displaying an image representing the information to be output. For example, the output apparatus 25 may output information as sound. That is, the output apparatus 25 may include a sound apparatus (so-called speaker) capable of outputting sound. For example, the output apparatus 25 may output information onto paper. That is, the output apparatus 25 may include a printing apparatus (so-called printer) capable of printing desired information onto paper.

### 2-3: Information Processing Operations Performed by the Information Processing Apparatus 2

Referring to FIG. 3, the information processing operations performed by the information processing apparatus 2 will be described. FIG. 3 is a flowchart showing the flow of information processing operations performed by the information processing apparatus 2. Note that this disclosure assumes that the first image is the real image and not the fake image.

As shown in FIG. 3, the receiving unit 211 receives input of the first image (Step S20). The receiving unit 211 may receive input of a face image containing a person's face region as the first image. The first image may be a still image. Hereinafter, “the first image” may be referred to as “a source image”.

The receiving unit 211 receives input of the second image (step S21). The receiving unit 211 may receive input of a face image containing a person's face region as the second image. The second image may be a still image. The second image may be a video. The second example embodiment describes processing in case where the second image is the still image. Hereinafter, “the second image” may be referred to as “a determination target image”.

The synthesis unit 212 generates a third image based on the first image and the second image. Hereinafter, “the third image” may be referred to as “a synthetic image”. The synthesis unit 212 may generate the synthetic image using a technique such as Face Swap. Face swap is a technique that swaps the face region of a source image with the face region of a target image. The synthesis unit 212 may generate the synthetic image by fitting the face region of the determination target image into the face region of the source image. The synthesis unit 212 may generate the synthetic image possessing characteristics of the source image. For example, the synthesis unit 212 may generate the synthetic image while maintaining the facial expression of the source image.

The extraction unit 2131 extracts the difference between the determination target image and the synthetic image (step S23). Alternatively, the extraction unit 2131 may be described as extracting the portions where the determination target image and the synthetic image differ. The extraction unit 2131 may calculate the difference in pixel values for each pixel and generate a difference image representing each pixel by its pixel value difference.

The emphasizing unit 2132 emphasizes the difference (step S24). The emphasizing unit 2132 may, for example, further emphasize the differences by multiplying each pixel value in the difference image by a real number. That is, the emphasizing unit 2132 may increase the pixel values of pixels in the difference image whose values are not zero (i.e., where there is no difference in pixel values between the determination target image and the synthetic image). Hereinafter, the difference image with its differences emphasized by the emphasizing unit 2132 may be referred to as “a difference-enhanced image”. The emphasizing unit 2132 may generate the difference-enhanced image by, for example, setting the pixel values of pixels in the difference image that are not zero to the maximum value they can take. The emphasizing unit 2132 may generate the difference-enhanced image by, for example, setting the pixel values of pixels in the difference image to a predetermined threshold or higher, up to the maximum possible pixel value. The emphasizing unit 2132 may generate the difference-enhanced image capable of having four types of pixel values, such as large difference, medium difference, small difference, and no difference, by setting the range of pixel values in the difference image. The emphasizing unit 2132 may employ any method to emphasize the difference.

The calculation unit 214 calculates an index representing the likelihood that the determination target image is the fake image based on the difference emphasized (step S25). The index calculated by the calculation unit 214 may be a real number. The calculation unit 214 may calculate an index representing the likelihood of the determination target image being the fake image using a calculation model. The calculation model is a model that outputs an index representing the likelihood of an image being the fake image in case where the difference emphasized is input. The calculation model may be a machine learning model. The learning mechanism that trains the calculation model may train the calculation model using a difference-enhanced image as training data, wherein the difference-enhanced image has information indicating the correct answer (whether the determination target image is the real image or the fake image). The learning mechanism may train the calculation model to compute the index representing the likelihood that the second image is the fake image, using information indicating the correct answer and the index output by the calculation model.

The determination unit 215 determines whether the second image is the synthetic image based on the index (Step S26). The determination unit 215 may determine whether the second image is a synthetic image by comparing the index with a predetermined threshold.

In case where the index exceeds the predetermined threshold (Step S26: Yes), the determination unit 215 determines that the second image is the synthetic image (Step S27). In case where the index does not exceed the predetermined threshold (Step S26: No), the determination unit 215 determines that the second image is an unsynthetic image (Step S28).

The output unit 216 performs output corresponding to the determination result (Step S29). The output unit 216 may control the output apparatus 25 to perform output corresponding to the determination result.

### 2-4: Technical Effects of the Information Processing Apparatus 2

In case where of using a difference emphasized for the comparison determination between the determination target image and the synthetic image, the difference between cases where the determination target image is the fake image and cases where it is not becomes easier to understand, making it easier to determine whether the determination target image is the fake image. The second information processing apparatus 2 according to the present disclosure detects with high accuracy whether the determination target image input is the fake image by emphasizing the difference between the determination target image input and the synthetic image synthesized and performing determination based on the difference emphasized. Furthermore, since the information processing apparatus 2 determines whether an image is fake or not by comparing it with a threshold value, so by setting the threshold value, it is possible to adjust how likely an image must be to be a fake image before it is determined to be a fake image.

### 3: Third Example Embodiment

The third example embodiment of an information processing apparatus, information processing method, and recording medium is described. The following describes the third example embodiment of an information processing apparatus, information processing method, and recording medium using a third information processing apparatus 3 of the present disclosure. The third example embodiment describes the case where the second image is the video comprising multiple frames. Hereinafter, “the second image” may be referred to as “a determination target video”. Furthermore, the video depicting events that did not actually occur may be referred to as a fake video. Conversely, the video depicting events that actually occurred may be referred to as a real video.

### 3-1: The Fake Video

For example, the real video may include a video showing the actions taken by the person B in front of the camera as captured by the camera. In contrast, the fake video may include the video where actions performed by the person B in front of the camera are synthesized to appear as if performed by the person A, who is different from the person B.

There exists technology called Reenactment that generates the fake video where the facial expression of the person in an original image changes to a desired expression, or the person in the original image faces a desired direction. For example, a known technique generates a video (sometimes referred to as “a still image be converted into a video”) where, based on at least one face image of the person A, the expression of the person A in that face image is changed to match the facial expression of the person B, making it appear as in case where the person A is changing

By using the original image and an original video, the still image can be converted into a video. The original video may be, for example, the video capturing actions performed by the person B in front of the camera. Furthermore, the original image may be the still image depicting the person A, who is different from the person B. In video conversion of the still image, first, landmarks are detected in the original image. The landmarks are also detected in each video frame composing the original video. Subsequently, for each video frame composing the original video, the original image is edited to match its landmarks with the video frame's landmarks, generating a synthetic frame. By connecting each generated synthetic frame, the still image can be converted into a video. The landmarks may be characteristic positions of subject appearing in the image.

For example, using the facial landmarks of the person B appearing in the original video, the orientation and expression of the person A's face appearing in the original image can be changed, enabling the synthesis of a video showing changes in person A's facial orientation and expression. The landmarks used to change a person's facial orientation, expression, etc., may be characteristic regions on the face. Characteristic positions on the face may be specific points on features such as the eyes, nose, or mouth.

In case where the video acquired is similar to the synthetic video synthesized using the still image, the video acquired is highly likely to be the fake video. This example embodiment utilizes this property to determine whether a video is a fake video. Specifically, in the third example embodiment, the system generates the synthetic video using the still image and compares the video acquired with the synthetic video to determine whether the acquired video is a fake video.

### 3-2: Configuration of the Information Processing Apparatus 3

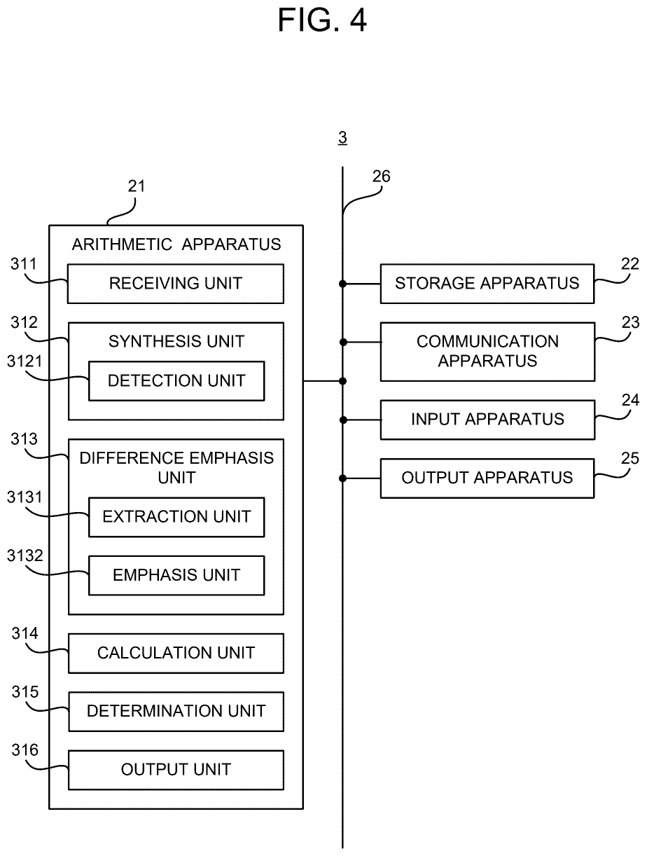

Referring to FIG. 4, the configuration of the third information processing apparatus 3 is described. FIG. 4 is a block diagram showing the configuration of the third information processing apparatus 3.

As shown in FIG. 4, the third information processing apparatus 3, like the second information processing apparatus 2, includes the arithmetic apparatus 21 and the storage apparatus 22. Furthermore, the third information processing apparatus 3 may also include, like the second information processing apparatus 2, the communication apparatus 23, the input apparatus 24, and the output apparatus 25. However, the third information processing apparatus 3 may not include at least one of the communication apparatus 23, the input apparatus 24, and the output apparatus 25. The third information processing apparatus 3 differs from the second information processing apparatus 2 in that a synthesis unit 312 includes a detection unit 3121. Other features of the information processing apparatus 3 may be identical to other features of the information processing apparatus 2. Therefore, the following description will detail only the parts differing from the already described example embodiment, omitting explanations for other overlapping parts as appropriate.

### 3-3: Information Processing Operations Performed by the Information Processing Apparatus 3

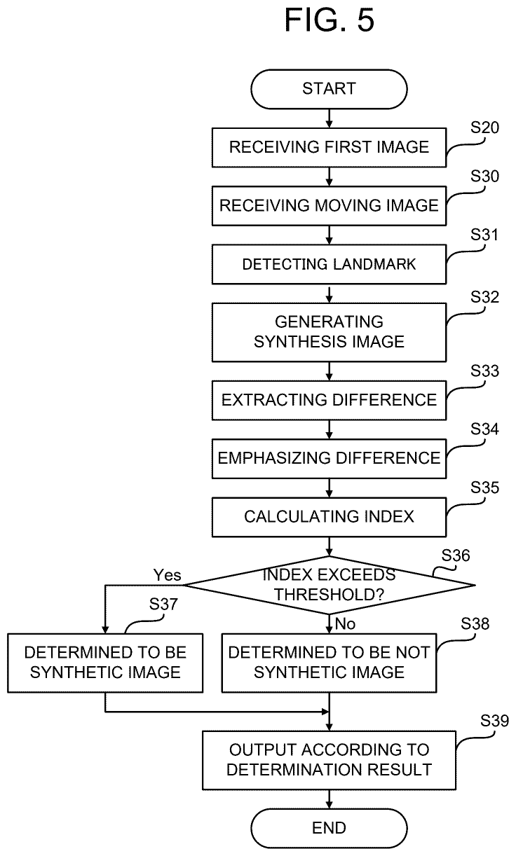

Referring to FIG. 5, the flow of information processing operations performed by the information processing apparatus 3 will be described. FIG. 5 is a flowchart showing the flow of information processing operations performed by the information processing apparatus 3.

As shown in FIG. 5, a receiving unit 311 receives input of the source image as the first image (Step S20). The detection unit 3121 detects landmarks from the source image. The detection unit 3121 may detect, as landmarks from the still image, characteristic positions within the face region. The detection unit 3121 may detect, as landmarks from the source image, specific points of features such as the eyes, nose, and mouth.

The receiving unit 311 receives input of the determination target video as the second image (step S30). The detection unit 3121 detects landmarks from each of one or more frames included in the determination target video (step S31). The one or more frames contained in the determination target video may be all frames contained in the determination target video. The one or more frames contained in the determination target video may be any one or more frames contained in the video. The detection unit 3121 may detect, from the determination target image, positions equivalent to the landmarks detected from the source image as landmarks.

The synthesis unit 312 synthesizes the third image based on the source image, the landmarks of the source image, and the respective landmarks of one or more frames included in the determination target video (step S32). In the third example embodiment, the third image is the synthetic video containing one or more frames. Hereinafter, “the third image” may be referred to as “the synthetic video”.

The synthesis unit 312 may first generate a synthetic frame edited to align the landmarks of the source image with the landmarks of each input frame constituting the determination target video. Subsequently, the synthesis unit 312 may generate the synthetic video by connecting each synthesized frame, thereby converting the source image, which is the still image, into a video.

An extraction unit 3131 extracts the difference between the determination target video and the synthetic video (step S33). The extraction unit 3131 extracts the difference between a frame contained in the determination target video and a frame contained in the synthetic video corresponding to that frame. The extraction unit 3131 may extract the difference between the determination target video and the synthetic video to generate a difference video. In case where the determination target video dᵢ contains frames from 1 to F, the determination target video dᵢ may be represented as [xᵢ¹, . . . , xᵢ^{F}]. In case where the synthetic video contains frames d_{f} from 1 to F, the synthetic video d_{f} may be represented as [x_{f}¹, . . . , x_{f}^{F}]. In this case, the difference video d_{diff} may be represented as d_{f}−dᵢ=[|x_{f}¹−xᵢ¹|, . . . , |x_{f}^{F}−xᵢ^{F}|]. In step S31, in case where the detection unit 3121 detects landmarks from one or more arbitrary frames contained in the determination target video, the extraction unit 3131 may generate the difference video containing difference frames corresponding to said one or more arbitrary frames.

An emphasis unit 3132 emphasizes the difference (step S34). The emphasis unit 3132 may generate a difference emphasis video containing difference emphasis frames that emphasizes the difference between frames included in the determination target video and frames included in the synthetic video corresponding to that frame. The difference emphasis video d_{diff} generated by the emphasis unit 3132 may be expressed as [α|x_{f}¹—xᵢ¹|, . . . , α|x_{f}^{F}−xᵢ^{F}|]. α is a real number and is a parameter for emphasizing the difference more strongly.

A calculation unit 314 calculates an index representing the fake video-likeness of the determination target video based on one or more frames contained in the difference emphasis video (step S35). The calculation unit 314 may calculate the index representing the fake image-likeness of the determination target image using a calculation model. In the third example embodiment, in case where one or more frames contained in the difference emphasis video are input, the calculation model outputs an index representing the fake image-like quality of the image. The one or more frames contained in the difference emphasis video may be all frames contained in the difference emphasis video. The one or more frames contained in the difference emphasis video may be any one or more frames contained in the video.

The determination unit 315 determines whether the determination target video is the fake video based on the index (step S36). The determination unit 315 may determine whether the determination target video is the fake video by comparing the index with a predetermined threshold.

In case where the index exceeds a predetermined threshold (Step S36: Yes), the determination unit 315 determines that the determination target video is the fake video (Step S37). In case where the index does not exceed the predetermined threshold (Step S36: No), the determination unit 315 determines that the determination target video is not the fake video (Step S38). An output unit 316 outputs a result corresponding to the determination (Step S39).

### 3-4: Technical Effects of the Information Processing Apparatus 3

The still image and the synthetic video generated using landmarks can capture the characteristics of the fake video generated using technologies such as deepfakes. The third information processing apparatus 3 according to the present disclosure utilizes the property that in case where the features of the synthetic video generated using the still image input (i.e., the source image) are similar to v of the determination target video input, the determination target video is highly likely to be the fake video. The third information processing apparatus 3 according to this disclosure can accurately determine whether the determination target video is an unchanged the real video or a falsified the fake video. Furthermore, the information processing apparatus 3 can accurately detect whether the determination target video input is the fake video based on frame-by-frame differences. Furthermore, the information processing apparatus 3 can accurately detect deepfakes generated using landmarks.

### 4: Fourth Example Embodiment

The fourth example embodiment of an information processing apparatus, information processing method, and recording medium is described. The following describes the fourth example embodiment of an information processing apparatus, information processing method, and recording medium using a fourth information processing apparatus 4 of the present disclosure.

### 4-1: Configuration of the Information Processing Apparatus 4

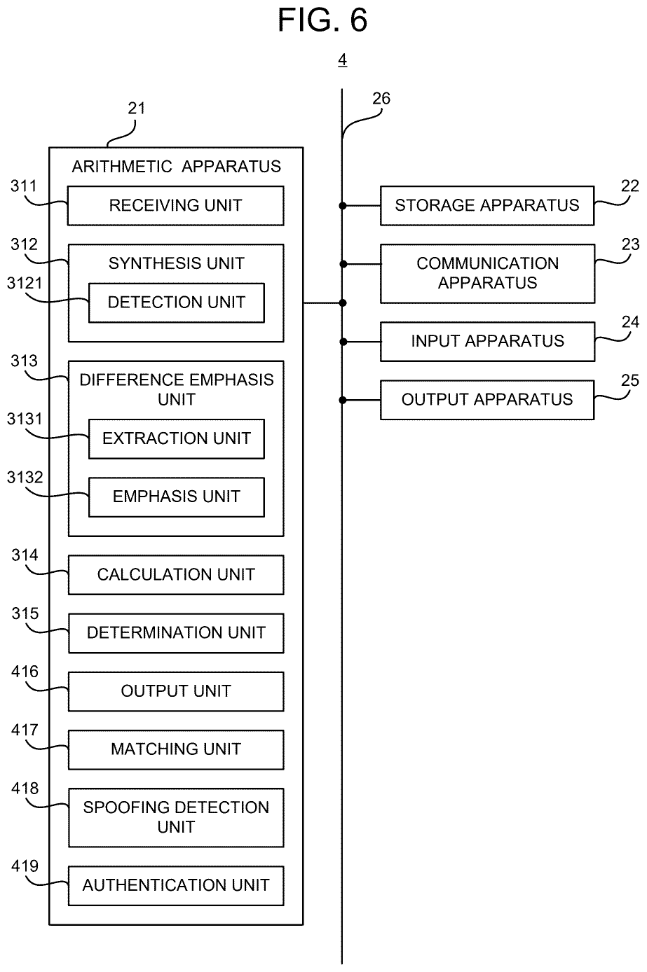

Referring to FIG. 6, the configuration of the fourth information processing apparatus 4 is described. FIG. 6 is a block diagram showing the configuration of the fourth information processing apparatus 4.

As shown in FIG. 6, the fourth information processing apparatus 4, like the second information processing apparatus 2 and the third information processing apparatus 3, includes the arithmetic apparatus 21 and the storage apparatus 22. Furthermore, the fourth information processing apparatus 4 may also include the communication apparatus 23, the input apparatus 24, and the output apparatus 25, similar to the second information processing apparatus 2 and the third information processing apparatus 3. However, the fourth information processing apparatus 4 may not include at least one of the communication apparatus 23, the input apparatus 24, and the output apparatus 25. The fourth information processing apparatus 4 differs from the second information processing apparatus 2 and the third information processing apparatus 3 in that a matching unit 417, a spoofing detection unit 418, and an authentication unit 419 are additionally implemented within the arithmetic apparatus 21. Other features of the fourth information processing apparatus 4 may be identical to other features of at least one of the second information processing apparatus 2 and the third information processing apparatus 3. Therefore, the following description will detail only the parts differing from the already described example embodiments, omitting explanations for other overlapping parts as appropriate.

The fourth information processing apparatus 4 is a mechanism capable of performing biometric authentication of individuals. The information processing apparatus 4 may be a mechanism that performs image-based matching operations and uses images to determine whether an individual is impersonating another person, thereby enabling authentication of the individual.

The fourth information processing apparatus 4 according to this disclosure may be applied to online know your customer processes such as electronic Know Your Customer (eKYC). As mentioned above, technology exists to synthesize an image of a person based on a single face photograph, posing a threat of spoofing in eKYC. Accurate determination of whether a video is fake is a critical challenge for enhancing the reliability of services like eKYC. Inputs to eKYC include face images from official documents, which can be used as information to synthesize fake videos. This means that as spoofing for eKYC, it is conceivable to synthesize a fake video based on limited information, such as the face image from an official document like a driver's license or My Number card, and input it.

### 4-2: Information Processing Operations Performed by the Information Processing Apparatus 4

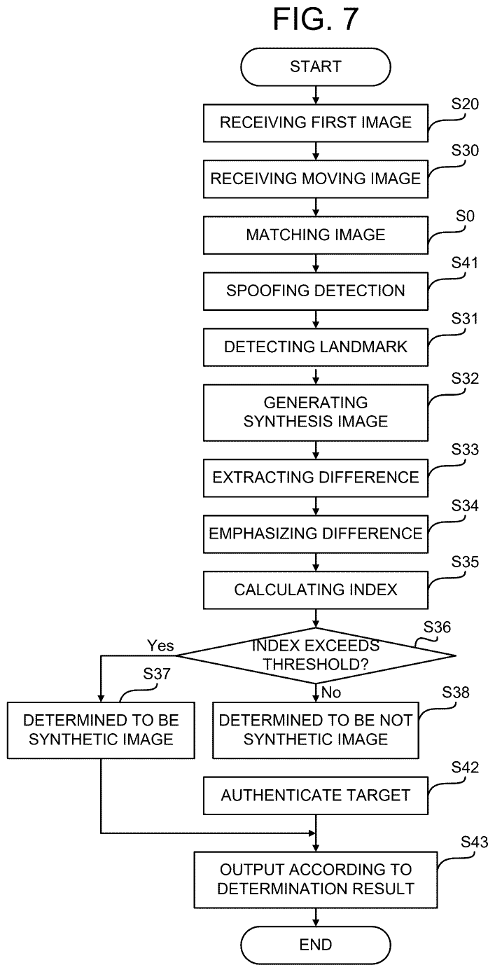

Referring to FIG. 7, the flow of information processing operations performed by the information processing apparatus 4 is explained. FIG. 7 is a flowchart illustrating the flow of information processing operations performed by the information processing apparatus 4. Note that in the fourth example embodiment as well, we describe the case where the second image is the video comprising multiple frames, and refer to the second image as the determination target video.

As shown in FIG. 7, the receiving unit 311 receives input of the source image as the first image (Step S20). The receiving unit 311 may also receive input of a face photograph from the know your customer documents, such as a driver's license or My Number Card, as the source image. The receiving unit 311 receives input of the determination target video as the second image (Step S30).

The matching unit 417 performs a face image comparison (Step S40). In case where the first image is a face image from an official document such as a driver's license or My Number card, the matching unit 417 may compare the person depicted in the first image with the person depicted in the determination target video. In this case, in case where the matching between the person in the first image and the person in the determination target video fails, the information processing operation may terminate. Alternatively, the matching unit 417 may match the first image received with pre-registered face images. Alternatively, the matching unit 417 may compare the determination target video received with a pre-registered face image. That is, the matching unit 417 may perform a comparison on at least one of the person appearing in the first image and the person appearing in the determination target video.

Furthermore, since the source image as the first image and the fake video synthesized based on that the source image are similar, even in case where the determination target video is the fake video, the possibility of a successful match between the first image and the determination target video is high.

The spoofing detection unit 418 performs spoofing detection using the determination target video (Step S41). In the fourth example embodiment, the determination target video may be used for spoofing detection alongside determining whether it is the fake video. For example, the determination target video may be a video showing actions performed by a person based on instructions from the information processing apparatus 4. The information processing apparatus 4 may instruct the orientation of the face, the direction of the gaze, and the position of the face. The information processing apparatus 4 may guide the gaze. The information processing apparatus 4 may instruct gestures. The spoofing detection unit 418 may perform an active liveliness determination using the determination target video.

The detection unit 3121 detects landmarks from each of one or more frames contained in the determination target video (step S31). The synthesis unit 312 generates the synthetic video based on the source image and the landmarks from each of one or more frames contained in the determination target video (step S32). The synthesis unit 312 generates the synthetic image based on the face photograph as the source image.

The extraction unit 3131 extracts the difference between a frame contained in the determination target video and a frame contained in the synthetic video corresponding to that frame (step S33). The emphasis unit 3132 emphasizes the difference (Step S34).

The calculation unit 314 calculates an index representing the likelihood that the determination target video is the fake video based on the difference video (Step S35). The determination unit 315 determines whether the determination target video is the fake video based on the index (Step S36). The determination unit 315 may determine whether the determination target video is the fake video by comparing the index with a predetermined threshold.

In case where the index exceeds the predetermined threshold (Step S36: Yes), the determination unit 315 determines that the determination target video is the fake video (Step S37). In case where the index does not exceed the predetermined threshold (Step S36: No), the determination unit 315 determines that the determination target video is not the fake video (Step S38).

In case where the determination unit 315 determines that the determination target video is not the fake video, the authentication unit 419 authenticates the person based on the matching result from the matching unit 417 and the determination result from the spoofing detection unit 418 (Step S42). Additionally, the authentication unit 419 may authenticate the person provided that the determination unit 315 determines that the determination target video is less likely to be the fake image than a predetermined standard, and the spoofing detection unit 418 determines that the person performed the instructed action. Successful authentication by the authentication unit 419 may also mean that the know your customer for the person has been completed. An output unit 416 outputs the person's authentication result (Step S43).

### 4-3: Technical Effects of the Information Processing Apparatus 4

The fourth information processing apparatus 4 of the present disclosure can accurately detect whether an input determination target video is a fake video, thereby enabling accurate Know Your Customer (KYC) verification.

### 5: Supplementary Note

The following supplementary note is disclosed regarding the example embodiments described above.

### Supplementary Note 1

An information processing apparatus including:
a receiving means for receiving input of a first image and a second image;
a synthesis means for generating a third image based on the first image and the second image;
a difference emphasis means for emphasizing a difference between the second image and the third image;
a calculation means for calculating an index representing a likelihood that the second image is a synthetic image based on the difference emphasized; and
a determination means for determining whether the second image is a synthetic image based on the index.

### Supplementary Note 2

The information processing apparatus according to Supplementary Note 1, wherein the difference emphasis means includes:
an extraction means for extracting the difference between the second image and the third image; and
an emphasis means for emphasizing the difference.

### Supplementary Note 3

The information processing apparatus according to Supplementary Note 1 or 2, wherein
the second image is a moving image including a plurality of frames;
the synthesis means generates the third image including one or more frames;
the difference emphasis means emphasizes the difference between a one frame included in the second image and a frame included in the third image corresponding to the one frame.

### Supplementary Note 4

The information processing apparatus according to Supplementary Note 3, wherein
the difference enhancement means generates a difference-enhanced video including difference frames that emphasize the differences between frames included in the second image and frames included in the third image that correspond to the frames, and
the calculation means calculates the index representing the likelihood of the second image being the synthetic image based on the difference-enhanced video.

### Supplementary Note 5

The information processing apparatus according to Supplementary Note 3, wherein
the synthesis means includes a detection means for detecting landmarks from the second image,
the third image is generated by synthesis based on the first image and the landmarks.

### Supplementary Note 6

The information processing apparatus according to Supplementary Note 1 or 2, wherein
the determination means for determining whether the second image is the synthetic image by comparing the index with a predetermined threshold.

### Supplementary Note 7

The information processing apparatus according to Supplementary Note 1 or 2, comprising:
a matching means for matching at least one of a target appearing in the first image and a target appearing in the second image; and
an authentication means for authenticating the target based on at least one of and a result of the determining by the determination means and a result of the matching by the matching means.

### Supplementary Note 8

An information processing method including:
receiving input of a first image and a second image;
generating a third image based on the first image and the second image;
emphasizing a difference between the second image and the third image;
calculating an index representing a likelihood that the second image is a synthetic image based on the difference emphasized; and
determining whether the second image is a synthetic image based on the index.

### Supplementary Note 9

A recording medium on which a computer program is stored, the computer program being configure to allow a computer to execute an information processing method including:
receiving input of a first image and a second image;
generating a third image based on the first image and the second image;
emphasizing a difference between the second image and the third image;
calculating an index representing a likelihood that the second image is a synthetic image based on the difference emphasized; and
determining whether the second image is a synthetic image based on the index.

The present disclosure has been described with reference to the example embodiments, but the disclosure is not limited to the example embodiments described above. Various modifications may be made to the configuration and details of the disclosure within the scope of the disclosure that would be understood by those skilled in the art. Furthermore, each example embodiment may be combined with other example embodiments as appropriate.

### DESCRIPTION OF REFERENCE CODES

1, 2, 3, 4 information processing apparatus
11, 211, 311 receiving unit
12, 212, 312 synthesis unit
13, 313 difference emphasis unit
14, 214, 314 calculation unit
15, 215, 315 determination unit
2131, 3131 extraction unit
2132, 3132 emphasis unit
216, 316, 416 output unit
3121 detection unit
417 matching unit
418 spoofing detection unit
419 authentication unit

What is claimed is:

1. An information processing apparatus comprising:
at least one memory storing instructions; and
at least one processor that is configured to execute the instructions for:
receiving input of a first image and a second image;
a generating a third image based on the first image and the second image;
emphasizing a difference between the second image and the third image;
calculating an index representing a likelihood that the second image is a synthetic image based on the difference emphasized; and
determining whether the second image is a synthetic image based on the index.

2. The information processing apparatus according to claim 1, wherein the at least one processor that is configured to execute the instructions for:
extracting the difference between the second image and the third image; and
emphasizing the difference.

3. The information processing apparatus according to claim 1, wherein
the second image is a moving image including a plurality of frames, and the at least one processor that is configured to execute the instructions for:
generating the third image including one or more frames; and
emphasizing the difference between a one frame included in the second image and a frame included in the third image corresponding to the one frame.

4. The information processing apparatus according to claim 3, wherein the at least one processor that is configured to execute the instructions for:
generating a difference-enhanced video including difference frames that emphasize the differences between frames included in the second image and frames included in the third image that correspond to the frames, and
calculating the index representing the likelihood of the second image being the synthetic image based on the difference-enhanced video.

5. The information processing apparatus according to claim 3, wherein the at least one processor that is configured to execute the instructions for
detecting landmarks from the second image, and
the third image is generated by synthesis based on the first image and the landmarks.

6. The information processing apparatus according to claim 1, wherein the at least one processor that is configured to execute the instructions for
determining whether the second image is the synthetic image by comparing the index with a predetermined threshold.

7. The information processing apparatus according to claim 1, wherein the at least one processor that is configured to execute the instructions for:
matching at least one of a target appearing in the first image and a target appearing in the second image; and
an authenticating the target based on at least one of a result of the determining and a result of the matching.

8. An information processing method comprising:
receiving input of a first image and a second image;
generating a third image based on the first image and the second image;
emphasizing a difference between the second image and the third image;
calculating an index representing a likelihood that the second image is a synthetic image based on the difference emphasized; and
determining whether the second image is a synthetic image based on the index.

9. A non-transitory recording medium on which a computer program is stored, the computer program being configured to allow a computer to execute an information processing method comprising:
receiving input of a first image and a second image;
generating a third image based on the first image and the second image;
emphasizing a difference between the second image and the third image;
calculating an index representing a likelihood that the second image is a synthetic image based on the difference emphasized; and
determining whether the second image is a synthetic image based on the index.
